(19) United States
(12) Patent Application Publication
(10) Pub. No.: US 2004/0237689 A1
(43) Pub. Date: Dec. 2, 2004

(54) Toothed wheel with a toroidal, curved pitch surface and toothed gearing with said toothed wheel

(76) Inventor: Roland Hiltbrand, Zofingen (CH)

Correspondence Address: BROWDY AND NEIMARK, P.L.L.C., 624 NINTH STREET, NW, SUITE 300, WASHINGTON, DC, 20001-5303, US

(21) Appl. No.: 10/482,654

(22) PCT Filed: Jul. 1, 2002
(86) PCT No.: PCT/EP02/07148

(30) Foreign Application Priority Data
Jul. 3, 2001 (CH) 1224/01
Jul. 12, 2001 (CH) 1311/01

(51) Int. Cl. F16H 55/08

(52) U.S. Cl. 74/457

(57) ABSTRACT

The invention relates to a toothed wheel (4) for mounting in a toothed gearing (1), wherein the toothed wheel (4) and a cylindrical gear (8) form a gear pair. The toothed wheel (4) has a curved pitch surface (5) with teeth, which comprises at least one tooth (7) extending spirally. The toothed wheel (4) is configured for mounting in the gear pair in such a way that the axis (2) of the toothed wheel (4) extends substantially perpendicular relative to the axis of the cylindrical gear (8).

The present invention relates to a gearwheel having a curved pitch surface and a gear having such a gearwheel. The gear preferably includes a pair of gears having a gearwheel with a toroidal, curved pitch surface and having a gearwheel with cylindrical external teeth.

### RELATED ART

There are numerous different configurations and constellations of gearwheel pairs in which two gearwheels interact with one another. The gearwheel pairs may be dimensioned and designed appropriately depending on the intended purpose and field of use. A gearwheel pair forms a simple gear or may be used as a component of a gear train.

Two gear constructions are differentiated between according to the mutual position of the wheel axes and/or the shafts of a gearwheel pair and according to the direction of the flanks: specifically rolling gear transmission and helical rolling type gear transmission.

Spur gears and bevel gear pairs are examples of rolling gear transmissions. Spur helical gears, bevel helical gears, and worm gear pairs, in contrast, are referred to as helical rolling type gear transmissions.

All of the known gear types are distinguished by certain specific advantages, which are, however, connected to certain disadvantages without exception.

The rolling gear transmissions, for example, are simple to manufacture and have low wear and good efficiency because they only roll on one another.

The helical rolling type gear transmissions are distinguished by quiet running, for example.

Large transmission ratios may not be implemented at a reasonable outlay and with compact dimensions using any of the known gear types. The exception is worm gears, which have poor efficiency, however. Planetary gear transmissions are to be considered a special case in this context, since these require more than one gearwheel pair per transmission ratio step.

It is an object of the present invention to avoid the disadvantages of the known gear types.

It is an object of the present invention to, as much as possible, combine all advantages of the known gears in a novel gear geometry and to provide a corresponding gearwheel and/or gear.

These objects are achieved by the characterizing features of claim 1 and by the characterizing features of claim 10, each in connection with the features of the preamble.

Different advantageous embodiments may be inferred from dependent claims 2-9 and 11-18.

Further details and advantages of the present invention are described in the following on the basis of preferred exemplary embodiments with reference to the drawing, which is implemented as simplified schematic illustrations.

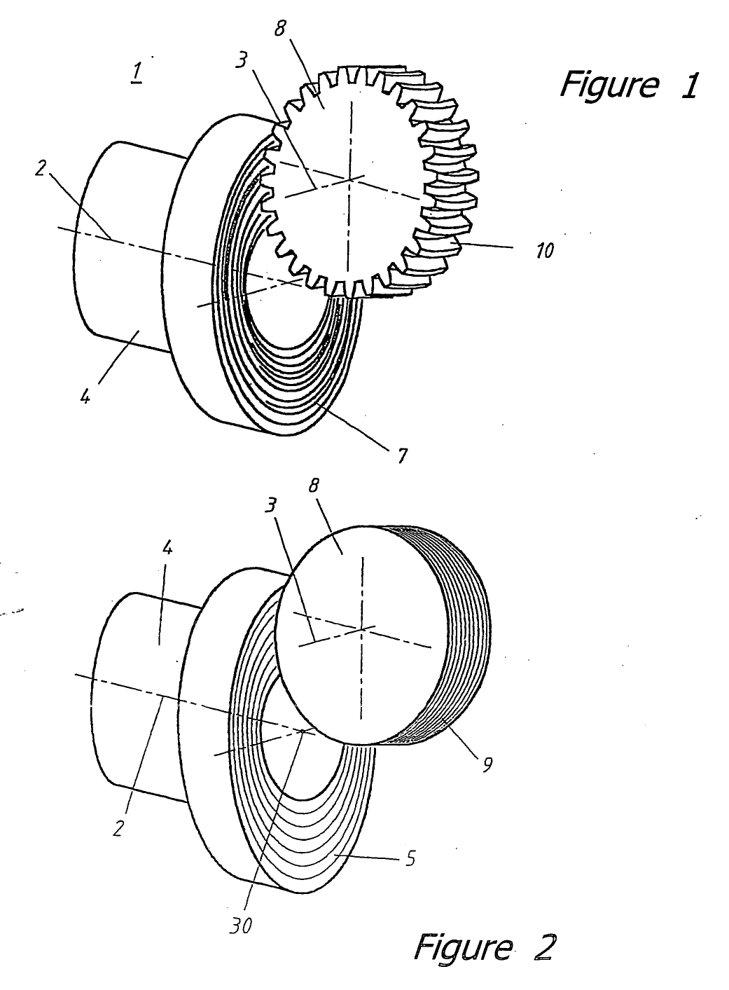

FIG. 1 shows a first gearwheel pair (torus spiral gear) in a perspective illustration with a driving torus wheel and a driven spur wheel, according to the present invention;

FIG. 2 shows a schematic illustration of the first gearwheel pair shown in FIG. 1, having the two functional faces (pitch surfaces), which represent a toric section and a cylinder;

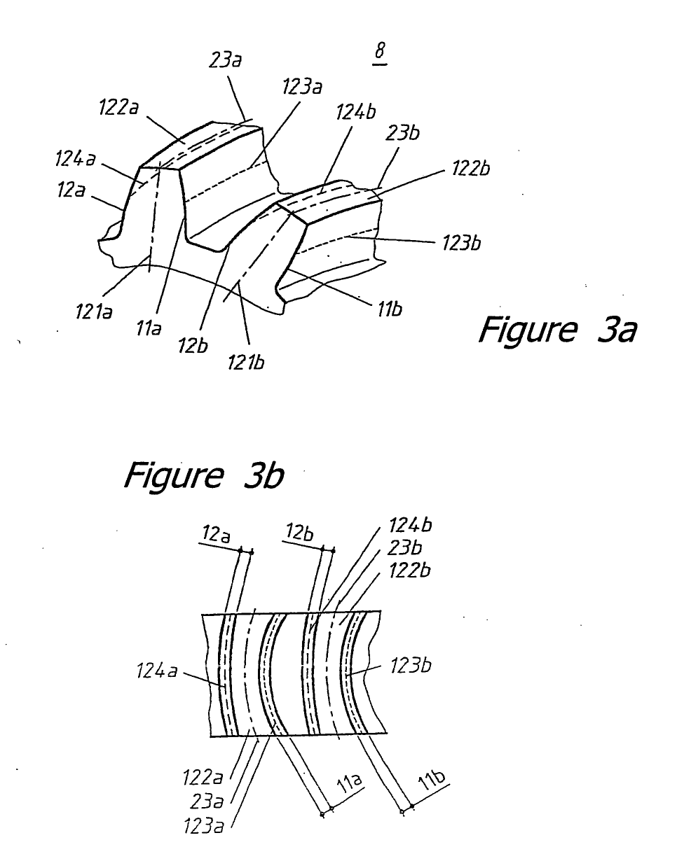

FIG. 3a shows a detail of a spiral-toothed spur wheel, according to the present invention, having its non-parallel left (e.g., concave, convex, or straight) and right convex tooth flanks;

FIG. 3b shows a detail of a top view of the spiral-toothed spur wheel shown in FIG. 3a;

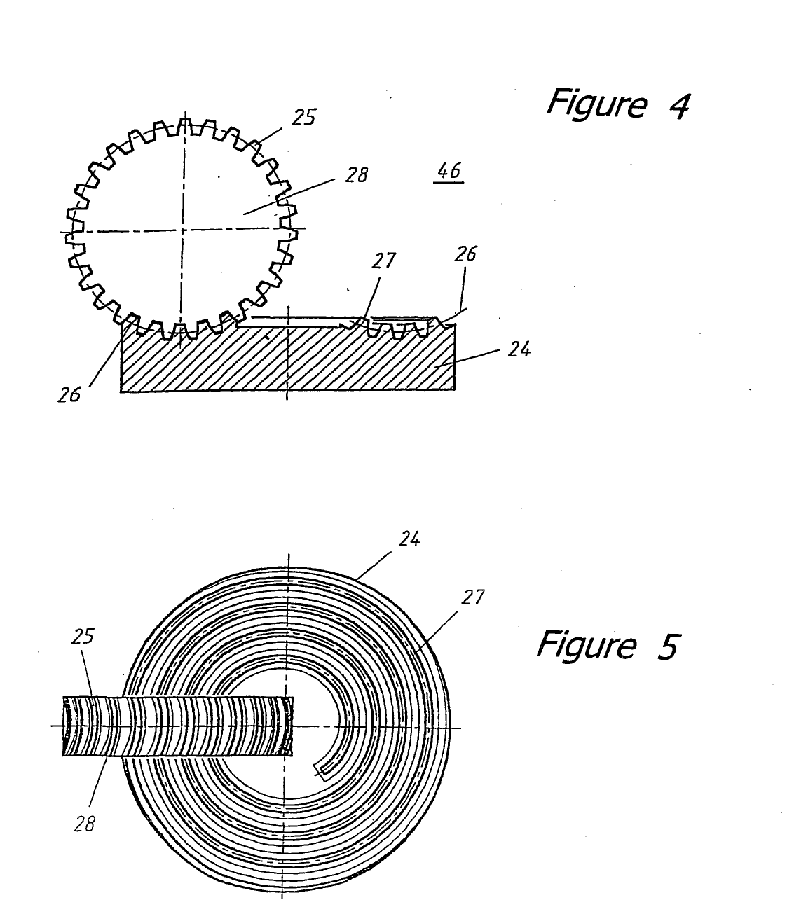

FIG. 4 shows the tooth meshing between a torus wheel and a spiral-toothed spur wheel according to a further gearwheel pair according to the present invention;

FIG. 5 shows the torus wheel having a spiral-toothed spur wheel in front of it, as shown in FIG. 4;

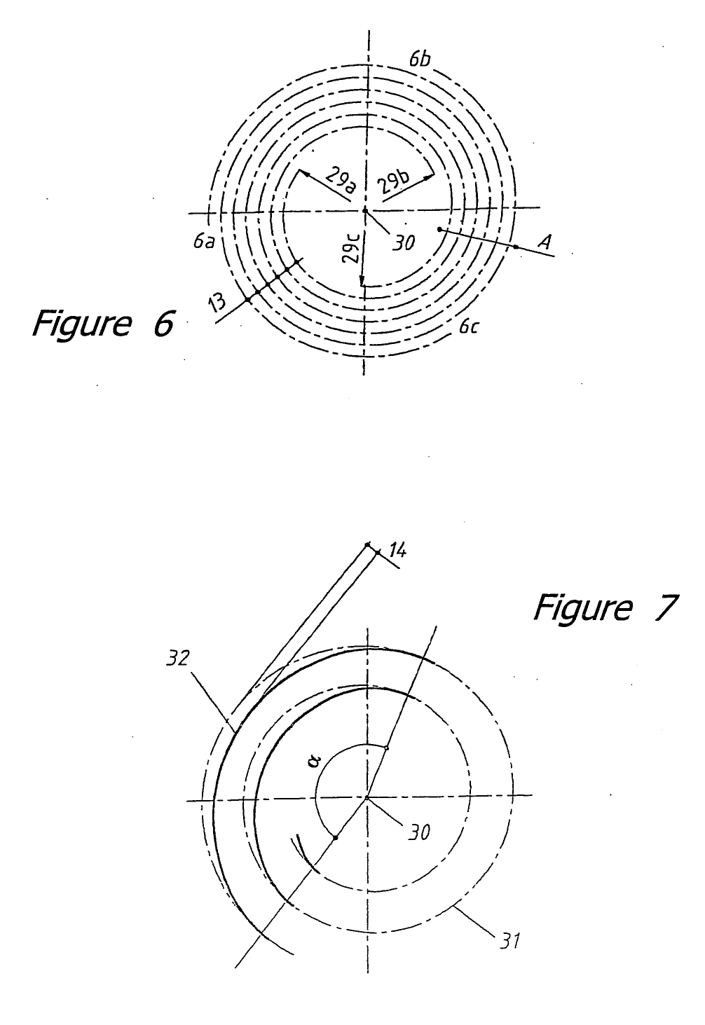

FIG. 6 shows a schematic illustration of the three tooth curves of a torus wheel provided with three teeth according to a further embodiment according to the present invention;

FIG. 7 shows a schematic illustration of a torus wheel having a tooth curve which deviates from the ideal spiral at multiple points, according to a further embodiment according to the present invention;

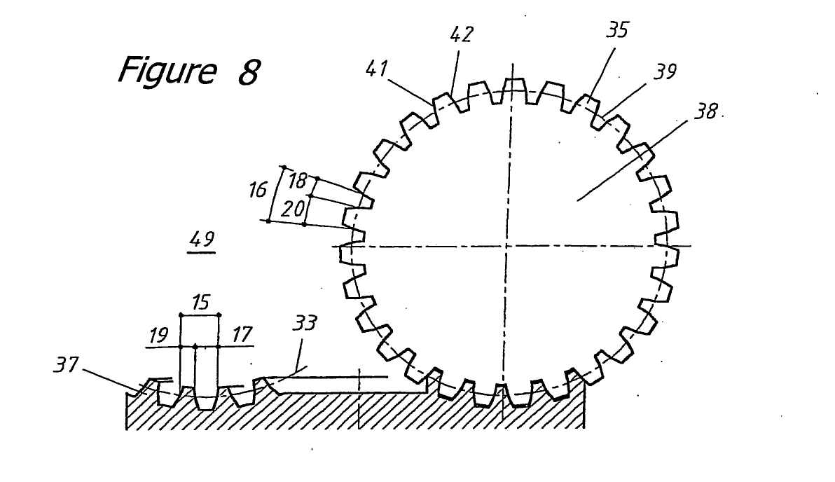

FIG. 8 shows the tooth meshing between a torus wheel having an expanded gap width and a spiral-toothed spur wheel having an expanded tooth thickness, according to a further embodiment according to the present invention;

FIG. 9 shows the teeth of a further torus wheel having a possibility for the design of the tooth flank profile, according to a further embodiment according to the present invention;

FIG. 10 shows the teeth of the spur wheel having a possibility for the design of the tooth flank profile, according to a further embodiment according to the present invention;

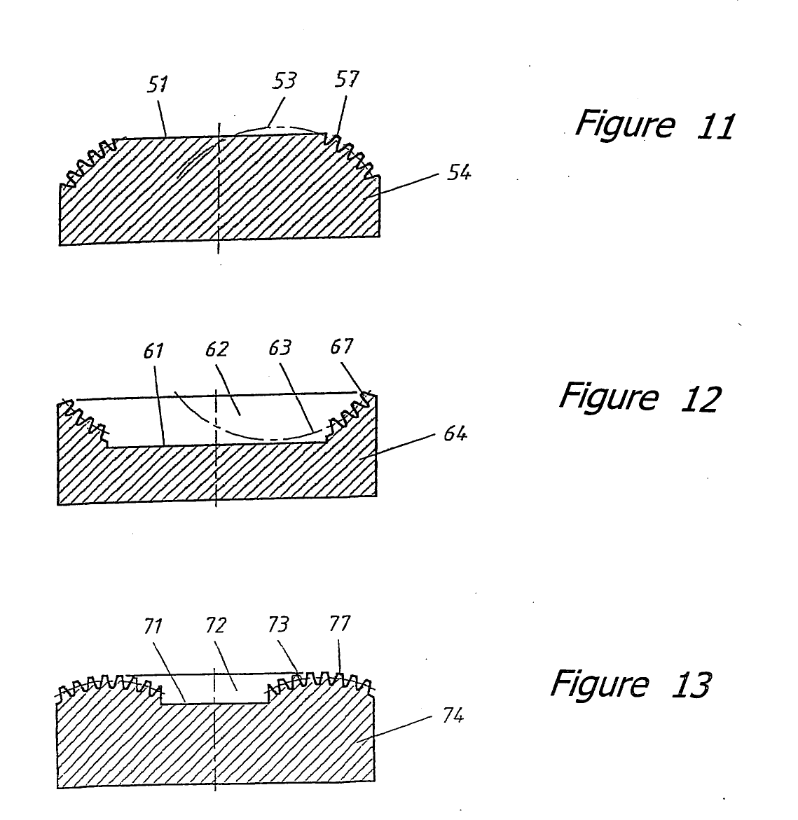

FIG. 11 shows the teeth and pitch surface of a further gearwheel having a convex pitch surface shaped like a toroidal segment, according to the present invention;

FIG. 12 shows the teeth and pitch surface of a further gearwheel having a concave pitch surface shaped like a toroidal segment, according to the present invention;

FIG. 13 shows the teeth and pitch surface of a further gearwheel having a convex pitch surface shaped like a toroidal segment, according to the present invention;

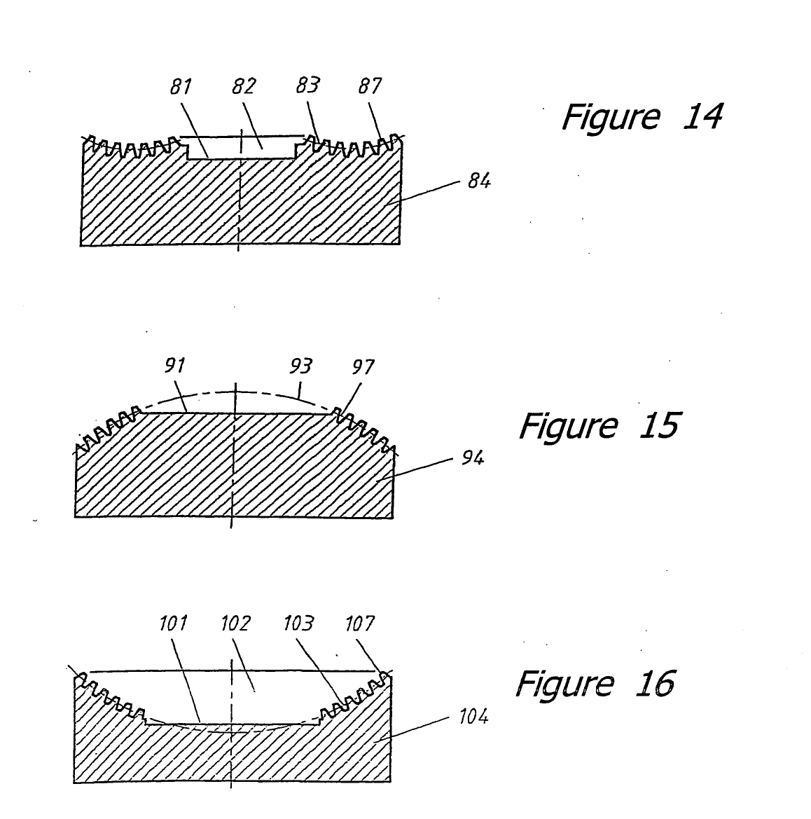

FIG. 14 shows the teeth and pitch surface of a further gearwheel having a concave pitch surface shaped like a toroidal segment, according to the present invention;

FIG. 15 shows the teeth and pitch surface of a further gearwheel having a convex pitch surface shaped like a spherical segment, according to the present invention;

FIG. 16 shows the teeth and pitch surface of a further gearwheel having a concave pitch surface shaped like a spherical segment, according to the present invention;

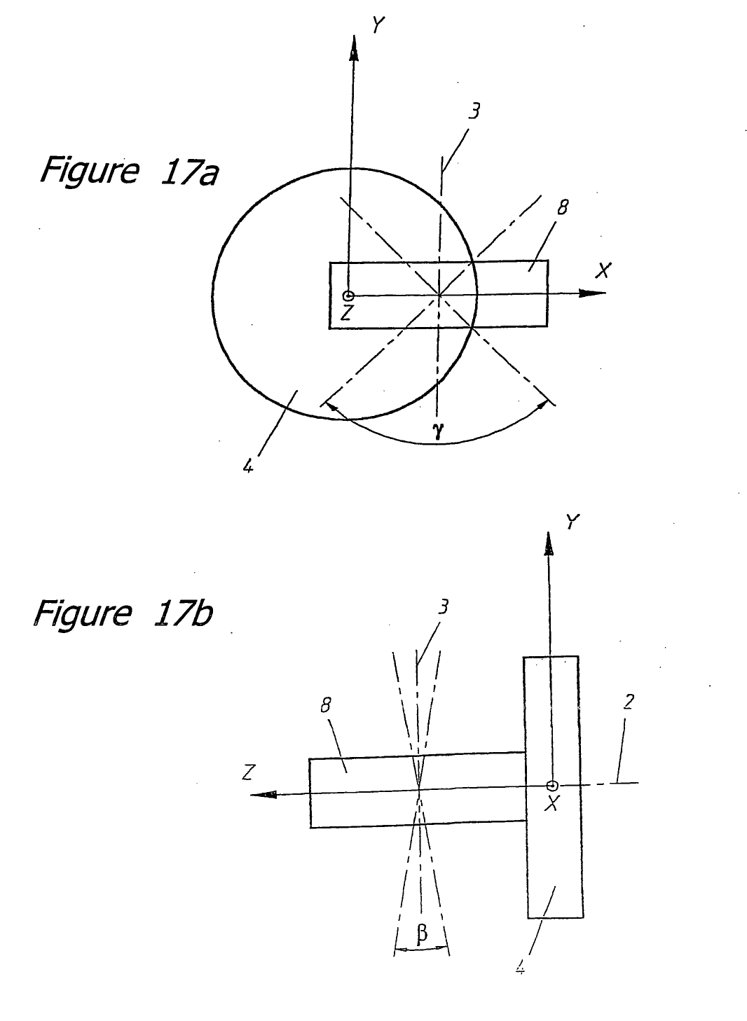

FIG. 17a shows a top view of a pair of gears according to the present invention;

FIG. 17b shows a side view of the pair of gears shown in FIG. 17a; and

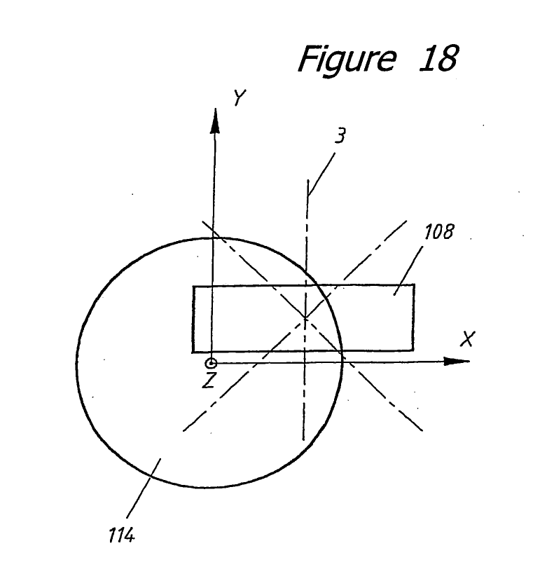

FIG. 18 shows a further pair of gears according to the present invention.

### DETAILED DESCRIPTION

In the following, different exemplary embodiments are provided. The expressions typical in gearing technology, which may be inferred from the DIN 3998 handbook or the DIN 868 handbook, for example, are used as the basis for the concept definitions.

A first gearwheel pair 1 (gear) according to the present invention as shown in FIG. 1 includes a first gearwheel 4 and a second gearwheel 8. The first gearwheel 4 is used as the drive wheel 4 and the second gearwheel 8 as the driven wheel. The two wheel axes 2 and 3 are approximately perpendicular to one another in the example shown, i.e., the axis angle is 90°±10°. The driving wheel 4 is a torus wheel having teeth 7 which run in a spiral shape. The driven wheel 8 is a spur wheel having curved external teeth 10.

Through this arrangement of the axes 2 and 3 and the teeth, two geometrically different pitch surfaces (shown hatched) result, as shown in FIG. 2, specifically an annular face (toric section) 5 and a cylinder surface 9. From the statements above, the gear 1 may thus be referred to as a helical rolling type gear transmission. The torus wheel 4 is provided with one or more teeth 7, each of the teeth 7 having a tooth curve running in a spiral. The coordinate origin 30 of all tooth curves running in a spiral is preferably a shared point lying on the wheel axis 2 in this case.

The spur wheel 8 has at least three teeth 10 applied in a curve. An exemplary detail in regard to the spiral teeth of the spur wheel 8 having concave left flanks 11a, 11b and convex right flanks 12a, 12b is shown in FIGS. 3a and 3b as a detail of the spur wheel 8. It is to be noted that the left flanks could also be straight or convex instead of concave. The tooth curve 23a and 23b is defined in connection with the present description as the intersection line (passage line) of the tooth central planes 121a and/or 121b with the upper tooth faces 122a, 122b. The tooth central planes 121a and 121b run in a fan shape in relation to one another and have a shared axis of intersection, which is coincident with the axis of rotation of the spur wheel 8. This axis of intersection is not visible in FIG. 3. The spur wheels 8 according to the present invention are distinguished in that each active flank region has at least one line which runs parallel to the same line of the neighboring tooth. The concave left flank 11a has, for example, the line 123a in the example shown, which runs parallel to the same line 123b of the concave left flank 11b of the neighboring tooth. The convex right flank 12a has the line 124a in the example shown, which runs parallel to the same line 124b of the convex right flank 11b of the neighboring tooth.

According to the present invention, the inner flanks (indicated in FIGS. 3a and 3b as left flanks 11a, 11b) may be shaped convex, straight, or concave. The outer flanks (indicated in FIGS. 3a and 3b as right flanks 12, 12) are implemented as convex (or as a polygonal approximation of a convex shape), the radius of curvature of these flanks being greater than the radius of the tooth curve of the teeth applied in a spiral shape on the pitch surface of the torus wheel 5.

The tooth curve 23a and the curve of the lines 123a and 124a are not necessarily parallel.

The second gearwheel 8 preferably has a cylindrical pitch surface 9, which is positioned concentrically to the wheel axis 3 of the second wheel 8.

A further embodiment of a gearwheel pair 46 according to the present invention is shown in FIG. 4. The torus wheel 24 has an at least partially curved pitch surface 26 which carries teeth having at least one tooth 27. The tooth/teeth 27 has/have a spiral tooth curve. In FIG. 4, the tooth meshing of the torus wheel 24 and the spur wheel 28 is shown. The curved pitch surface 26 is implemented as a concave toric section.

The curve of the teeth 27 of the torus wheel 24 applied in a spiral shape and the teeth 25 of the spur wheel 28 and the interplay of the teeth 27 and the spiral-toothed teeth 25 is shown again in FIG. 5 with the torus wheel 24 and the spur wheel 28 visible.

In order, as shown in FIG. 6, to obtain not only transmission ratios corresponding to the tooth number of a (driven) cylinder wheel, the (driving) torus wheel may have multiple teeth according to a further embodiment. Such a torus wheel is referred to as a multi-thread torus wheel. The tooth curves 6a, 6b, 6c of the teeth of such a torus wheel are positioned on the pitch surface as spirals whose shared coordinate origin 30 lies on the wheel axis of the torus wheel. The spirals are preferably Archimedean spirals, as indicated in FIG. 6, which are distinguished by constant coil intervals over the entire definition region A.

In the embodiment shown in FIG. 6, the spirals, viewed outward in the radial direction from the shared coordinate origin 30, have a uniform tooth spacing of the intervals of the tooth curves 6a, 6b, 6c. The origin vectors 29a, 29b, 29c of the tooth curves 6a, 6b, 6c running in a spiral are preferably distributed uniformly on 360°, so that the uniform tooth spacing is maintained.

FIG. 7 relates to a special embodiment of a gear according to the present invention. In the embodiment of the present invention described up to this point (see FIG. 5 or 6, for example) the tooth curves 6a, 6b, 6c of the spiral teeth 7 and/or 27 of the driving wheel 4 and/or 24 run around the coordinate origin 30 with uniform pitch. Uniform speed of the driven spur wheel 8 is thus ensured. However, if non-uniform angular speeds on the spur wheel 8 and/or 25 are desired, these may be produced through deviations from the uniform curve of the spirals. For example, flattenings may be provided in the curvature of the spirals. In connection with the present invention, a deviation of the curvature of a spiral from the uniform curve is referred to as a flattening. In FIG. 7, the example of a tooth curve 31 having flattenings 14 is shown. The uniform curve of the tooth curve 31 is shown in dashed form. In an angle section a, the tooth curve 31 deviates from the uniform curve, as is indicated by the thick line 32.

FIG. 8 shows a further embodiment of a gearwheel pair 49 according to the present invention. The first gearwheel 34 has an at least partially curved pitch surface 33 (indicated by a dashed line in FIG. 8). Teeth having multiple teeth 37 are located on the pitch surface 33. The tooth curves of the teeth 37 have a spiral curve. The second wheel 38 is a cylinder wheel having a cylindrical pitch surface 39 (indicated in FIG. 8 by a dashed, circular line), which has external teeth having teeth 35. The external teeth are spiral teeth having concave left flanks 41 and convex right flank 42, the concave left flanks 41 not running parallel to the convex right flanks 42. The possibility of a specific pitch 15, 16 of the gearwheel 34 and/or the cylinder wheel 38 is shown in FIG. 8. The pitch 15, 16 is a non-uniform pitch in tooth gaps 17, 18 and tooth widths 19, 20. The pitch is preferably performed in such a way that the gearwheel 34 has gaps 17 between neighboring teeth 37, whose width 17 is selected differently than the width 18 of the gaps between neighboring teeth 35 of the cylinder wheel 38. In another case, the thickness 19 of the teeth 37 (also referred to as tooth width) of the gearwheel 34 is selected in such a way that it differs from the thickness 20 of the teeth 35 of the cylinder wheel 38. A combination of these two provisions is also possible. Through such a pitch, the specific conditions in regard to strength values for the driving and/or driven wheel may be taken into consideration appropriately.

Two possible tooth shapes according to the present invention may be seen in FIGS. 9 and 10. FIG. 9 shows multiple teeth 47 of a further torus wheel 44. The curved pitch surface 43 is indicated in FIG. 9 by a dashed line. The pitch surface 43 is implemented as concave in the embodiment shown. There are numerous possibilities for designing the tooth flank profile of the teeth 47. FIG. 10 shows several teeth 40 of a spur wheel 48. The pitch surface 45 of the spur wheel 48 is cylindrical. There are also numerous possibilities for designing the tooth flank profile for the teeth 40. The selection of the tooth shape in regard to the flank profiles 21 and 22 is influenced by the manufacturing method, the manufacturing tool used, and the desired properties of the gear.

The teeth 57 and the pitch surface 53 of a further gearwheel 54 according to the present invention are shown in FIG. 11. The pitch surface 53 is convex and has the shape of a toric segment. The gearwheel 54 has a raised surface 51, preferably implemented as even, in the example shown.

The teeth 67 and the pitch surface 63 of a further gearwheel 64 according to the present invention are shown in FIG. 12. The pitch surface 63 is concave and has the form of a toric segment. The gearwheel 64 has a recessed surface 61, which is preferably implemented as even. The surface 61 is in a recess 62 in the example shown.

The teeth 77 and the pitch surface 73 of a further gearwheel 74 according to the present invention are shown in FIG. 13. The pitch surface 73 is convex and has the form of a toric section. The gearwheel 74 has a recessed surface 71, preferably implemented as even. The surface 71 is in a recess 72 in the example shown.

The teeth 87 and the pitch surface 83 of a further gearwheel 84 according to the present invention are shown in FIG. 14. The pitch surface 83 is concave and has the form of a toric section. The gearwheel 84 has a recessed surface 81, preferably implemented as even. The surface 81 is in a recess 82 in the example shown.

The teeth 97 and the pitch surface 93 of a further gearwheel 94 according to the present invention are shown in FIG. 15. The pitch surface 93 is convex and has the form of a spherical segment. The gearwheel 94 has a slightly recessed surface 91, preferably implemented as even.

The teeth 107 and the pitch surface 103 of a further gearwheel 104 according to the present invention are shown in FIG. 16. The pitch surface 103 is concave and has the form of a spherical segment. The gearwheel 104 has a recessed surface 101, preferably implemented as even, in the example shown. The surface 101 is in a recess 102.

The embodiments shown in FIGS. 12, 14, and 16 are distinguished in that more than two teeth of the spur wheel are always engaged.

The installation position of the two wheels of the pair of gears 4 and 8 is shown in FIGS. 17a and 17b on the basis of an x, y, z coordinate system. The rotational axis 3 of the spur wheel 8 may deviate from the perpendicular position at y=0° in the x-y plane. Preferably, for the angle y: −45°<y<45°. In addition, the rotational axis 3 may be tilted slightly in relation to the horizontals, as indicated in FIG. 17b. The tilt is defined by the angle β, for which: −10°<β<10°.

In a further embodiment, which is indicated in FIG. 18, the spur wheel 108 is positioned offset in relation to the torus wheel 114.

According to the present invention, one of the gearwheels (also referred to as the torus wheel) has a curved pitch surface, at least a section of which is implemented as concave or convex. The pitch surface according to the present invention is thus designed as toroidal or spherical in at least one section, the section of the pitch surface being

a toric section,

a spherical section,

a toric segment, or

a spherical segment.

The section of the pitch surface is positioned concentrically to the wheel axis of the gearwheel.

The field of use of gears described above extends over all of drive technology. The present invention is especially suitable for use in elevator construction, vehicle construction, and mechanical engineering in general. The present invention is especially suitable for use in cableways, crane hoists, etc.

As an expanded variant, the gear may be constructed as multiple pairs of gears (gear train). A gear train which combines both spiral-toothed pairs of gears and known pairs of gears such as spur wheels, bevel wheels, or others is also conceivable.

The use of the gear upon which this patent specification is based is connected with many advantages in dividers, turntables, or circular swivel units. One of these advantages is the slight tooth backlash, which may be set through axial displacement of the driving planar wheel.

It is an advantage of the gearwheel pair according to the present invention that it may be implemented as self-locking. In such a self-locking embodiment, the spur wheel may not drive the torus wheel.

It is also advantageous that, depending on the embodiment, multiple teeth are always engaged. In addition, a gearwheel pair according to the present invention may be constructed compactly. Transmission ratios of up to 200 per gearwheel pair step may be implemented. A gearwheel pair according to the present invention is distinguished by very high efficiency, since there is a fluid friction between the transmitting tooth flanks.

The installation of the gear upon which this patent specification is based is also very advantageous in conveyor technology, especially in chain hoists, cable hoists, and lifts. The self-locking cited may replace or supplement safety elements such as brakes.

1. A gear having a first wheel and a second wheel, wherein
the first wheel is a gearwheel having an at least partially curved pitch surface, which has a tooth system having at least one tooth, which has a spiral tooth curve, and
the second wheel is a cylinder wheel having a cylindrical pitch surface which has external teeth, which include at least three teeth and form spiral teeth having left flanks and having convex right flanks, the left flanks not running parallel to the convex right flanks.

2. The gear according to claim 1, wherein the first wheel is a torus wheel and the spiral tooth curve is designed as an Archimedean spiral, whose coordinate origin lies on the wheel axis of the first wheel.

3. The gear according to claim 1, wherein the first wheel is a multi-thread torus wheel having two or more teeth, the tooth curves of the teeth on the pitch surface being designed as spirals, whose shared coordinate origin lies on the wheel axis of the first wheel, a uniform spacing of the intervals of the tooth curves preferably resulting, viewed outward from the shared coordinate origin.

4. The gear according to claim 1, wherein the spiral tooth curve(s) deviates from the theoretical shape in one or more regions, so that the tooth curve has a flattening there.

5. The gear according to claim 1-4, wherein
the first wheel has gaps between neighboring teeth, whose width is selected differently than the width of the gaps between neighboring teeth of the second wheel, and/or
the thickness of the teeth of the first wheel is selected differently than the thickness of the teeth of the second wheel.

6. The gear according to claim 1, wherein the teeth of the first wheel and/or the teeth of the second wheel may have any arbitrary flank profile.

7. The gear according to 1, wherein the cylindrical pitch surface is positioned concentrically to the wheel axis of the second wheel.

8. The gear according to claim 1, wherein the curved pitch surface is implemented as concave or convex in a t least one section.

9. The gear according to claim 1, wherein the curved pitch surface is implemented as toroidal or spherical in at least one section.

10. The gear according to one of claims 8 or 9,
wherein the section is
a toric section,
a spherical section,
a toric segment, or
a spherical segment,
and the section is concentric to the wheel axis of the first wheel.

11. A gearwheel for installation in a gear in which the gearwheel forms a pair of gears with a cylinder wheel, and wherein
the gearwheel has an at least partially curved pitch surface,
there is a tooth system having at least one tooth on the partially curved pitch surface,
the tooth having a spiral tooth curve, which deviates in one or more regions from the theoretical shape, so that the tooth curve has a flattening there, and
the gearwheel is laid out for installation in the pair of gears in such a way that the wheel axis of the gearwheel runs in a defined position in relation to the wheel axis of the cylinder wheel.

12. The gearwheel according to claim 11, wherein the gearwheel is a torus wheel and the spiral tooth curve is designed as an Archimedean spiral, whose coordinate origin lies on the wheel axis of the gearwheel.

13. The gearwheel according to claim 11, wherein the gearwheel is a multi-thread torus wheel having two or more teeth, the tooth curves of the teeth on the pitch surface being designed as spirals, whose shared coordinate origin lies on the wheel axis of the gearwheel, a uniform spacing of the intervals of the tooth curves preferably resulting, viewed outward from the shared coordinate origin.

14. (Cancelled)

15. The gearwheel according to claim 11, wherein the teeth of the gearwheel may have any arbitrary flank profile.

16. The gearwheel according to claim 11, wherein the width of the gaps between neighboring teeth does not correspond to the thickness of the teeth.

17. The gearwheel according to claim 11, wherein the curved pitch surface is implemented as concave or convex in at least one section.

18. The gearwheel according to claim 11, wherein the curved surface is implemented as toroidal or spherical in at least one section.

19. The gearwheel according to one of claims 16 or 17, wherein the section is
a toric section,
a spherical section,
a toric segment, or
a spherical segment,
which is concentric to the wheel axis of the gearwheel.
